(19) United States
(12) Patent Application Publication
(10) Pub. No.: US 2018/0335072 A1
(43) Pub. Date: Nov. 22, 2018

(54) Push-On Spring Nut

(71) Applicant: ERICO INTERNATIONAL CORPORATION, Solon, OH (US)

(72) Inventors: Eric J. Wilson, Solon, OH (US); David Landphair, Kernersville, NC (US)

(21) Appl. No.: 15/986,469

(22) Filed: May 22, 2018

Related U.S. Application Data
(60) Provisional application No. 62/509,478, filed on May 22, 2017.

(51) Int. Cl. F16B 37/08

(52) U.S. Cl. CPC F16B 37/0842

(57) ABSTRACT

A push-on spring nut for attaching a threaded object to a structure can include a single-piece body with a base, a first arm, and a second arm. Each of the first and second arms can include a support portion extending from the base, a structure-engagement portion that extends laterally outwardly from the support portion, a connecting portion that extends laterally inwardly from an acutely angled junction with the structure-engagement portion, and a thread-engagement portion that extends laterally inwardly from the connecting portion. The single-piece body can be configured to be pushed partly through an opening of the structure to seat the structure-engagement portion against the structure, to support the single-piece body against axial loading opposite the first direction. The first and second arms can be configured to resiliently flex laterally outwardly to allow non-rotational axial insertion of the threaded object.

### CROSS-REFERENCE TO RELATED APPLICATIONS

This application claims priority to U.S. Provisional Patent Application No. 62/509,478, titled “Push-On Spring Nut” and filed on May 22, 2017, the entirety of which is incorporated herein by reference.

### BACKGROUND

In many applications, it may be useful to quickly attach a nut to a threaded object, in order to use the nut and the threaded object to support other structures. For example, it may be useful to attach a nut to a threaded rod to quickly attach to the threaded rod to a structure and/or to suspend a load.

### SUMMARY

Some embodiments of the invention provide a push-on spring nut for attaching to a threaded object. The push-on spring nut can include a housing and a spring nut insert. The housing can include first and second side walls shaped to form a hollow tube with an internal passageway configured to receive the threaded object. The first and second side walls can each include a window. The spring nut insert can be configured to be inserted into the internal passageway of the housing and can include first and second arms. At least a part of each of the first and second arms can be configured to engage a thread on the threaded object to secure the push-on spring nut to the threaded object, when the threaded object is received in the internal passageway of the housing and between the first and second arms.

The first and second arms can be laterally flexible and can be configured to: upon insertion of the spring nut insert into the internal passageway of the housing in a first direction, flex laterally inwardly and then outwardly to snap in to the windows of the first and second side walls, to secure the spring nut insert within the internal passageway of the housing; and, during non-rotational insertion of the threaded rod into the internal passageway of the housing in the first direction, flex laterally outwardly to allow the threaded rod to pass. The housing can be configured to provide support for the spring nut insert at the first and second arms, during axial loading of the threaded object opposite the first direction, via one or more features of the windows.

### DESCRIPTION OF THE DRAWINGS

FIG. 1 is a top, front, left isometric view of a push-on spring nut according to one embodiment of the invention.

FIG. 2 is a front elevation view of a spring nut insert of the push-on spring nut of FIG. 1 in an initial position when receiving a threaded rod.

FIG. 3 is a front elevation view of the spring nut insert of the push-on spring nut of FIG. 1 moving over a thread when receiving a threaded rod.

FIG. 4 is a front elevation view of the spring nut insert of the push-on spring nut of FIG. 1 snapped into a thread when engaging a threaded rod.

FIG. 5 is a front elevation view of the spring nut insert of the push-on spring nut of FIG. 1 with the spring nut insert attached to a threaded rod and a load applied to the threaded rod.

FIG. 6 is a top, front, right isometric view of a spring nut insert according to another embodiment of the invention.

FIG. 7 is front elevation view of the spring nut insert of FIG. 6.

FIG. 8 is a cross-section view of the spring nut insert of FIG. 6 taken along plane 8-8 in FIG. 7.

FIG. 9 is a top plan view of the spring nut insert of FIG. 6.

FIG. 10 is right side elevation view of the spring nut insert of FIG. 6.

FIG. 11 is a left side elevation view of the spring nut insert of FIG. 6.

FIG. 12 is a front elevation view of the spring nut insert of FIG. 6 illustrating certain forces acting on the spring nut insert.

FIG. 13 is a top, front, right isometric view of a spring nut insert according to still another embodiment of the invention.

FIG. 14 is a bottom plan view of the spring nut insert of FIG. 13.

FIG. 15 is a top plan view of the spring nut insert of FIG. 130

FIG. 16 is a front elevation view of the spring nut insert of FIG. 13.

FIG. 17 is a rear elevation view of the spring nut insert of FIG. 13.

FIG. 18 is a bottom, front, right isometric view of a housing for use with the spring nut insert of FIG. 13, according to an embodiment of the invention.

FIG. 19 is a top, front, right isometric view of the spring nut insert of FIG. 13 installed in the housing of FIG. 18.

FIG. 20 is a top, front, right isometric view of a single-piece spring nut body according to an embodiment of the invention.

FIG. 21 is a bottom plan view of the spring nut body of FIG. 20.

FIG. 22 is a front elevation view of the spring nut body of FIG. 20,

FIG. 23 is a top plan view of the spring nut body of FIG. 20.

FIG. 24 is a rear elevation view of the spring nut body of FIG. 20.

FIG. 25 is a right side elevation view of the spring nut body of FIG. 20.

FIG. 26 is a left side elevation view of the spring nut body of FIG. 20,

FIGS. 27 and 28 are isometric views of instances of the spring nut body of FIG. 20 installed, and being installed, on a racking angle.

FIG. 29 is a top, front, right isometric view of a single-piece spring nut body according to another embodiment of the invention.

FIG. 30 is a bottom plan view of the spring nut body of FIG. 29.

FIG. 31 is a top plan view of the spring nut body of FIG. 29.

FIG. 32 is a rear elevation view of the spring nut body of FIG. 29.

FIG. 33 is a front elevation view of the spring nut body of FIG. 29.

FIG. 34 is a right side elevation view of the spring nut body of FIG. 29.

FIG. 35 is a left side elevation view of the spring nut body of FIG. 29.

FIGS. 36 and 37 are isometric views of instances of the spring nut body of FIG. 29 installed on a racking angle.

FIG. 38 is an isometric view of instances of the spring nut body of FIG. 29 installed, and being installed, on a strut.

FIG. 39 is a top, front, right isometric view of a single-piece spring nut body according to yet another embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise specified or limited, the term “axial” (and the like) in the context of push-on spring nuts generally refers to a direction of insertion of a threaded object, such as the axial direction of an elongate threaded rod. Similarly, the term “lateral” (and the like) in the context of push-on spring nuts generally refers to a direction that extends perpendicularly relative to the axial direction. In this regard, lateral directions or movements can include, but are not limited to, radial directions or movements.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In the discussion below, various examples describe push-on spring nuts for attaching to a structure (e.g., a threaded rod) and suspending a load. It will be understood that the attachment to a threaded rod described are presented as examples only and that the disclosed push-on spring nut can he used to attach to other devices, such as threaded fasteners or other threaded objects, or other objects generally.

Some embodiments of the invention can provide push-on spring nuts with improved retention strength as compared to conventional designs. For example, in some embodiments of the invention, resilient arms can include support portions that connect to a spring-nut base, with structure-engagement portions extending laterally outwardly from the support portions. Further, connecting portions can extend at acute angles laterally inwardly from the structure-engagement portions to thread-engagement portions that are configured to engage the thread of a threaded object. Usefully, the laterally outward extension of the structure-engagement portions can position the structure-engagement portions to engage a structure near openings through which the spring nuts are inserted, in order to secure the spring nuts to relevant structures. Additionally, the combined structure of the laterally outwardly extending structure-engagement portions and the laterally inwardly extending connecting portions can contribute to a favorable balance of forces upon axial loading of a threaded object held by a spring nut according to the invention, which can result in increasingly firm attachment of the spring nut to the threaded object as the loading on the threaded object increases.

In some embodiments, arms of a spring-nut body, such as described above, can be formed as continuous features, without discrete, free-ended projections. For example, an arm of a spring-nut body can extend continuously from a spring-nut base along a support portion, then along a connecting portion, then along a thread-engagement portion to a free end configured to engage the thread of a threaded object. This may be useful, for example, in order to simplify manufacturing of the relevant spring nut, while also potentially increasing the spring nut for a given material thickness.

In some embodiments, push-on spring nuts according to the invention can include spring-nut inserts configured as single-piece spring-nut bodies (e.g., as discussed above) and separate housings, with the housings configured to receive the spring-nut inserts and secure the spring-nut inserts (and the assembly in general) to a structure. In some embodiments, push-on spring nuts according to the invention can include single-piece spring-nut bodies that are configure for installation directly onto a structure, without the need for a separate housing.

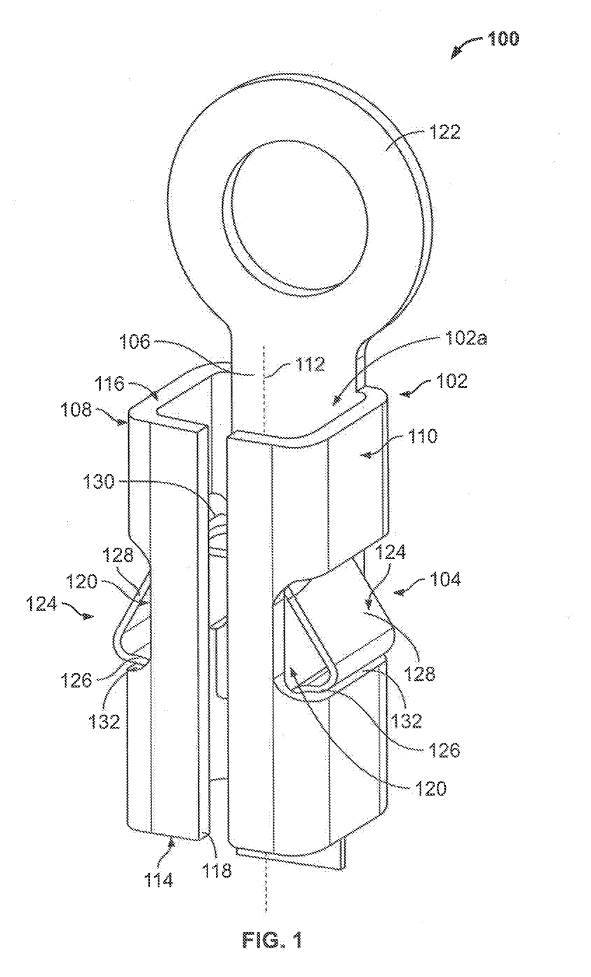

FIG. 1 illustrates a push-on spring nut 100 according to one embodiment of the invention. In some embodiments, the push-on spring nut 100 can be attached to a threaded object to support various structures. For example, the push-on spring nut 100 can be attached to a threaded rod to allow for quick coupling to a structure or load. In some embodiments, for example, the push-on spring nut 100 can be used to suspend a conduit, a pipe, a duct, or another structure. In some embodiments, the push-on spring nut 100 can be used in other settings.

The push-on spring nut 100 generally includes a housing 102 and a spring-nut insert 104 that is configured to be inserted into and secured within the housing 102. In some embodiments, the housing 102 can be unitarily formed from a single piece of material. In some embodiments, the housing 102 can be fabricated from a metal material (e.g., mild steel or spring steel).

In the embodiment illustrated, the housing 102 includes a base 106, a first side wall 108 and a second side wail 110, and defines a generally central axis 112, along which a central passage 102a extends axially through the housing 102 (e.g., generally vertically, from the perspective of FIG. 1). The central passage 102a extends between a first end 114 and a second end 116 of the housing 102. In the illustrated embodiment of FIG. 1, the first end 114 and the second end 116 of the housing 102 are generally open. This may be useful, for example, to enable a threaded rod and the spring-nut insert 104 to be axially inserted into the housing 102 along the central axis 112, as also discussed below.

In the illustrated embodiment of FIG. 1, the first and second side walls 108, 110 exhibit lateral symmetry relative to a plane extending perpendicularly from the base 106 and through the central axis 112. Further, the first and second side walls 108, 110 are formed integrally with and extend from opposing sides of the base 106. In other embodiments, other configurations are possible.

Generally, the first and second side walls 108, 110 are shaped to form the housing 102 into a hollow, generally rectangular tube-like structure, which defines the passage 102a and is capable of receiving the spring nut insert 104, as also described below. In other embodiments, for example, a housing for a spring nut may define a round, curved, polygonal, or other shape.

In the illustrated embodiment of the housing 102, a slot 118 extends axially along the housing 102 from the first end 114 to the second end 116. The slot 118 is generally formed between free ends of the first and second side walls 108, 110 (e.g., the ends of the first and second side wails 108, 110 not attached to the base 106). The slot 118 can, for example, allow the first and second side walls 108, 110 to flex somewhat independently of one another and/or with respect to the base 106.

Generally, the first and second side walls 108, 110 each include a window 120 disposed between the first end 114 and the second end 116. Each of the windows 120 defines a lateral cutout in the associated first or second side wall 108, 110, which generally extends axially along the respective side wall 108, 110. As also described below, the windows 120 can receive parts of the spring nut insert 104 within the housing 102, and can provide support for the spring nut insert 104 when a load is applied to the spring nut insert 104 (e.g., via a threaded rod).

In some embodiments, the housing 102 can be tapered internally, so that a size of the opening near the first end 114 is larger than a size of the opening near the second end 116. This taper can, for example, aid in manufacturing of the push-on spring nut 100, while also assisting in the insertion of a threaded rod through the housing 102. For example, due to the taper, a threaded rod or spring-nut insert can he relatively easily inserted into the first end 114, while the smaller size at the second end 116 can provide a somewhat restricted transition passage that provides additional support for a threaded rod extending therethrough.

Generally, a housing according to the invention can include any number or different configurations of structures to assist in securing the housing to other objects, such as building support structures. In the illustrated embodiment of FIG. 1, the housing 102 includes a rivet hole 122 formed in an extension of the base 106 of the housing 102. The rivet hole 122 can enable attachment of the push-on spring nut 100 to, for example, a conduit, a pipe, a duct, or another structure (not shown in FIG. 1). In other embodiments, for example, the housing 102 can include another structure (e.g., a clip, a threaded structure, a fastener, an interlocking feature, etc.) as opposed or in addition to the rivet hole 122. In some embodiments, for example, the housing 102 may be attached to, or integrally formed with, a fastening structure (e.g., a clip, a clamp, a bracket, a mounting plate, etc.).

Generally, as also discussed below, the spring nut insert 104 is configured to be received and retained by the housing 102. Accordingly, for example, the spring nut insert 104 includes a pair of opposing arms 124 that are designed to he resiliently flexible (e.g., in axial and/or lateral directions). In some embodiments, the arms 124 can be flexible enough to allow a threaded rod to pass therethrough in one direction without the threaded rod rotating, yet can be sufficiently resilient to return to firmly engage the threaded rod and to provide sufficient strength to resist movement of the threaded rod, without buckling, when the threaded rod is loaded in an opposite direction.

In some embodiments, the flexibility and elastic resiliency of the arms 124 enables the push-on spring nut 100 to provide a restorative action, or pre-bias, during insertion of a threaded rod. For example, the arms 124 can flex laterally outwardly as a crest of a thread of a threaded rod being inserted through the spring nut 100 passes between free ends of the arms 124. For example, the arms 124 can flex in a direction extending generally perpendicular to the central axis 112 through the respective side walls 108, 110. Further, restorative action due to the resiliency of the arms 124 can subsequently return (and further bias) the arms 124 laterally inwardly (e.g., toward the central axis 112 along respective lateral directions) and into gripping engagement with the threaded rod between the passed crest and a subsequent crest of the thread.

In some embodiments, a portion of the arms of a spring nut insert can be configured to extend outside of a housing (e.g., outside of a window of the housing) while the remainder of the spring nut insert, including thread-engagement portions of the arms, are disposed within the housing. In the embodiment illustrated in FIG. 1, for example, the arms 124 each include a structure-engagement portion configured as a housing support portion 126, an angled connecting portion 128, and a thread-engaging portion 130. In particular, the arms 124 extend continuously from connections with the base 106 along side wall portions of the arms 124 (not shown in FIG. 1), the housing support portions 126, the connecting portions 128, and the thread-engaging portions 130. Further, the arms 124 the each define a generally S-shaped profile along the housing support portions 126, junctions between the housing support portions 126 and the side wall portions, and junctions between the housing support portions 126 and the connecting portions 128, with the housing support portions 126 and the connecting portions 128 joining at acute angles laterally outside of the side wall portions.

Accordingly, with the spring nut 100 assembled as shown, the arms 124 initially curve laterally outward past a lower edge 132 of the respective window 120, and then angle laterally inwardly and axially upward at the junction between the housing support portions 126 and the connecting portions 128. From these junctions, the connecting portions 128 each extend axially toward the second end 116 of the housing 102 and laterally inwardly toward the central axis 112 at an angle between zero and ninety degrees relative to the central axis 112. In other embodiments, other configurations are possible. For example, whereas the connecting portions 128 are generally planar, connecting portion in some embodiments can extend inwardly with a curved or other non-planar profile.

The thread-engaging portions 130 extend from junctions with the connecting portions 128 of the arms 124, within the internal passage 102a of the housing 102 as installed, and are generally designed to cooperate to engage and secure a threaded rod that has been inserted through the housing 102 and between threaded portions 130. Accordingly, for example, the thread-engaging portions 130 can be arranged along a generally helix-like path to conform to a standard thread type on a threaded rod.

In some embodiments, as also discussed below, the thread-engaging portions 130 can exhibit a compound geometry. For example, a first portion of each of the thread-engaging portions 130 can exhibit a first geometry (e.g., as corresponds to a first projected angle of a thread) and a second portion of each of the thread-engaging portions 130 can exhibit a second geometry (e.g., as corresponds to a second projected angle of the thread).

In some embodiments, the spring nut insert 104 can be fabricated from a unitary piece of metal material. For example, the spring nut insert 104 can be stamped from spring steel or other material in a progressive die operation. In this regard, for example, the push-on spring nut 100 can sometimes be formed as two stamped pieces, of spring steel or other material. In other embodiments, other configurations, manufacturing approaches, and materials may be used.

In some implementations, to assemble the push-on spring nut 100, the spring nut insert 104 can be axially inserted, into the first end 114 of the housing 102. In some configurations, including for the configuration illustrated in FIG. 1, the insert 104 can be inserted with the arms 124 leading. In other configurations, the insert 104 can be inserted in an opposite direction.

Because the housing support portions 126 of the arms 124 are dimensioned to extend laterally past the side walls 108, 110, the connecting portions 128 can be urged into contact with ends of the side walls 108, 110 as the insert 104 is inserted. As a result, for example, as aided by the angled aspect of the angled portion 128, the arms 124 can be caused to flex laterally inwardly during the initial axial insertion of the spring nut insert 104 into the housing 102. Once the spring nut insert 104 is inserted axially far enough into the housing 102, so that that the housing support portions 126 of the arms 124 are aligned with the windows 120, the arms 124 can then resiliently spring laterally outwardly away from the central axis 112, to snap into engagement with the windows 120. In particular, in the embodiment illustrated, the housing support portions 126 can snap over the lower edges 132 of the windows 120, with the lower edges 132 of the windows thereby retaining the spring nut insert 104 within the housing 102 against axial withdrawal in the downward direction (e.g., from the perspective of FIG. 1).

In some embodiments, the above-described snap-in assembly of the push-on spring nut 100 can enable relatively quick assembly and installation of the push-on nut spring nut 100. Further, the illustrated two-piece configuration, and other configurations, can allow for relatively efficient manufacturing of the push-on nut spring nut 100. In some embodiments, an insert can be inserted from an opposite side of a housing. For example, the insert 104 can be inserted axially downwardly from the perspective of FIG. 1, with the underside of the support portions 126 bearing on the top ends of the side walls 108, 110 to help flex the aims 124 laterally inwardly.

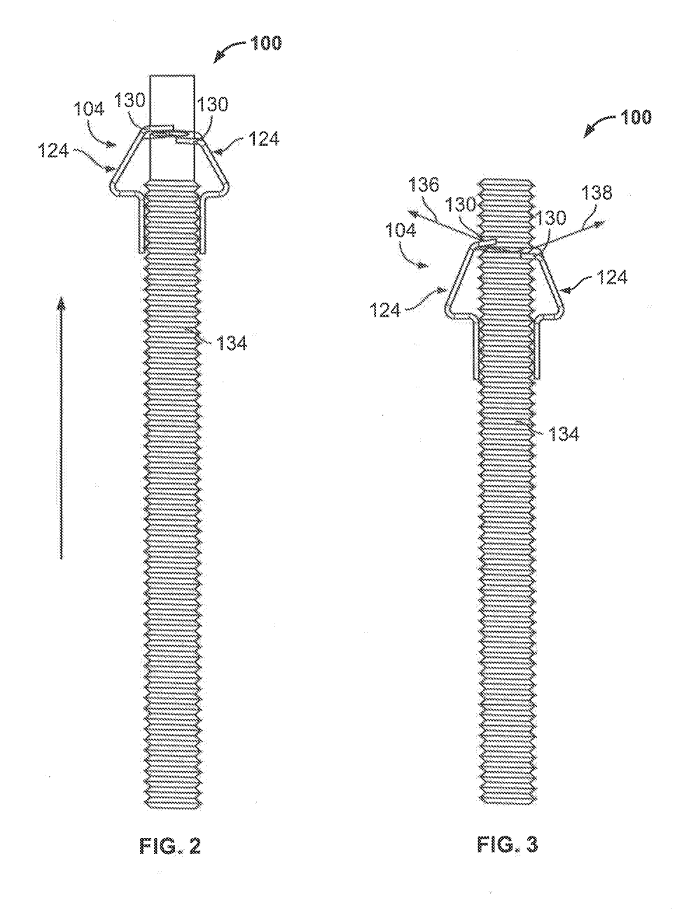

As illustrated in FIGS. 2 through 5, the push-on spring nut 100 is configured to be attached to a threaded rod 134 without requiring rotation of the threaded rod 134, in order to support an applied load. To better illustrate the interactions between the spring nut insert 104 and the threaded rod 134, the housing 102 is not shown in FIGS. 2 through 5.

As illustrated in FIG. 2, to attach the push-on spring nut 100 to the threaded rod 134, the push-on spring nut 100 can be initially pushed onto the threaded rod 134 (or, inherently, vice versa) so that the threaded rod 134 is inserted through the first end 114 of the housing 102 and into the internal passage 102a of the housing 102 (see FIG. 1). This generally positions the threaded rod 134 along the central axis 112 and aligns the threaded rod 134 to engage the thread-engaging portions 130 of the arms 124.

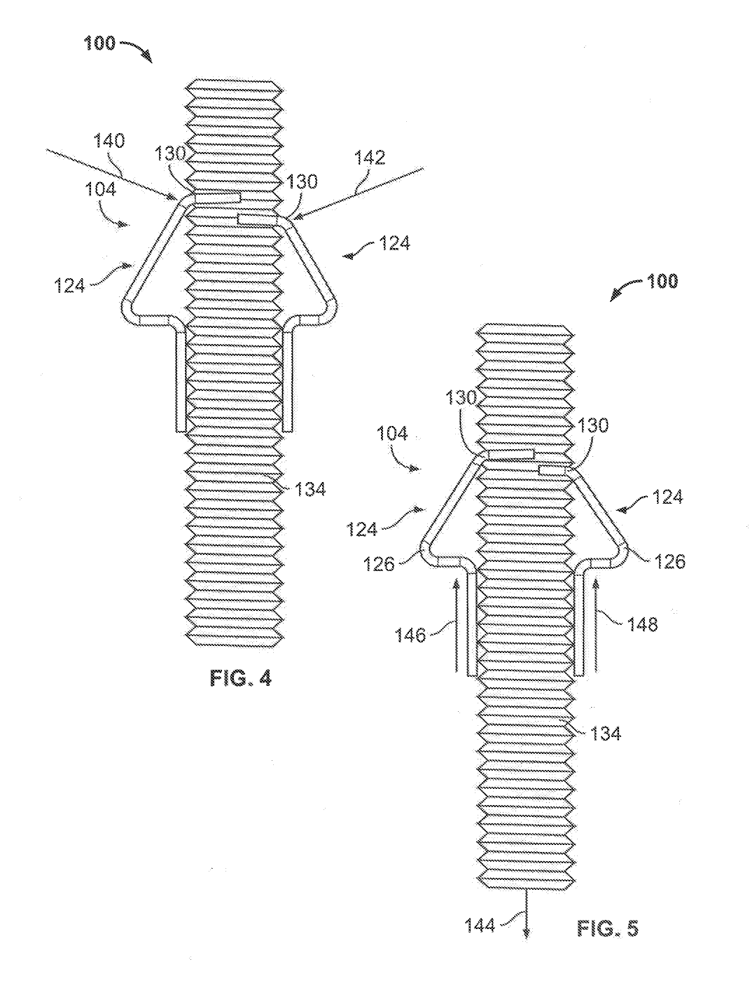

As illustrated in FIGS. 3 and 4, once the push-on spring nut 100 has been pushed onto the threaded rod 134 (or vice versa) far enough to engage the threaded rod 134 with the thread-engaging portions 130, the flexibility and design of the thread-engaging portions 130 generally enable arms 124 to flex laterally outwardly to admit the threaded rod 134 through the thread-engaging portions 130 in a first direction (i.e., upward in FIGS. 2 through 5). Further, the arms 124 are configure to resiliently spring laterally inward as each successive crest of the thread of the threaded rod 134 passes the thread-engagement portions 130, in order to automatically engage the subsequent threaded rod 134 between the passed crest and a subsequent crest, and thereby resist withdrawal of the threaded rod 134 in an opposite direction (i.e., downward in FIGS. 2 through 5). As illustrated in FIG. 3 in particular, when the thread-engaging portions 130 are passing over a crest of the thread of the threaded rod 134, the arms 124 can be flexed laterally outward (as indicated by arrows 136 and 138 and enabled by the windows 120 (see FIG. 1)) to enable the threaded rod 134 to pass therethrough. As illustrated in FIG. 4 in particular, as a subsequent root of the thread is moved into alignment with the thread-engaging portions 130, the restorative action of the arms 124 moves the thread-engaging portions 130 laterally inward (as indicated by arrows 140 and 142) into closer engagement with the thread generally (e.g., at or near the root).

In some embodiments, as illustrated in FIG. 5, a load may be applied to the threaded rod 134 in a first direction 144, such as an axial direction opposite an insertion direction of the threaded rod 134 into the spring nut 100. The load can be transferred to the push-on spring nut 100 at the location where the thread-engaging portions 130 engage the thread of the threaded rod 134. The load can then be transferred from the thread-engaging portions 130 along the arms 124 to the engagement between the housing support portions 126 and the lower edges 132 of the windows 120 (see, e.g., FIG. 1). The load applied to the threaded rod 134 can accordingly be counterbalanced by reaction forces 146 and 148 at the engagement between the housing support portions 126 and the lower edges 132 of the housing 102. Thus, the load applied to the threaded rod 134 may be transferred from the spring nut insert 104 to the housing 102 and the housing 102 can support the threaded rod 134 relative to another structure (not shown) to which the housing 102 is attached.

As also discussed below, due to the engagement between the housing support portions 126 and the lower edges 132 occurring at a location that is laterally outward from the engagement of the tread-engaging portions 130 with the thread of the threaded rod 134, loading of the threaded rod 134 can generate a reaction moment that generally urges the arms 124 and, in particular, the thread-engaging portions 130, into tighter engagement with the thread of the threaded rod 134. This can generally contribute to the thread-engaging portions 130 being firmly retained in engagement with the thread of the threaded rod 134 and can help to resist, for example, laterally outward forces generated from the angled interaction with the thread on the threaded rod 134. Indeed, with appropriate design (e.g., as illustrated for the spring nut 100), increases in loading on the threaded rod 134 can tend to increase the gripping force of the engagement of the spring nut 100 with the threaded rod 134.

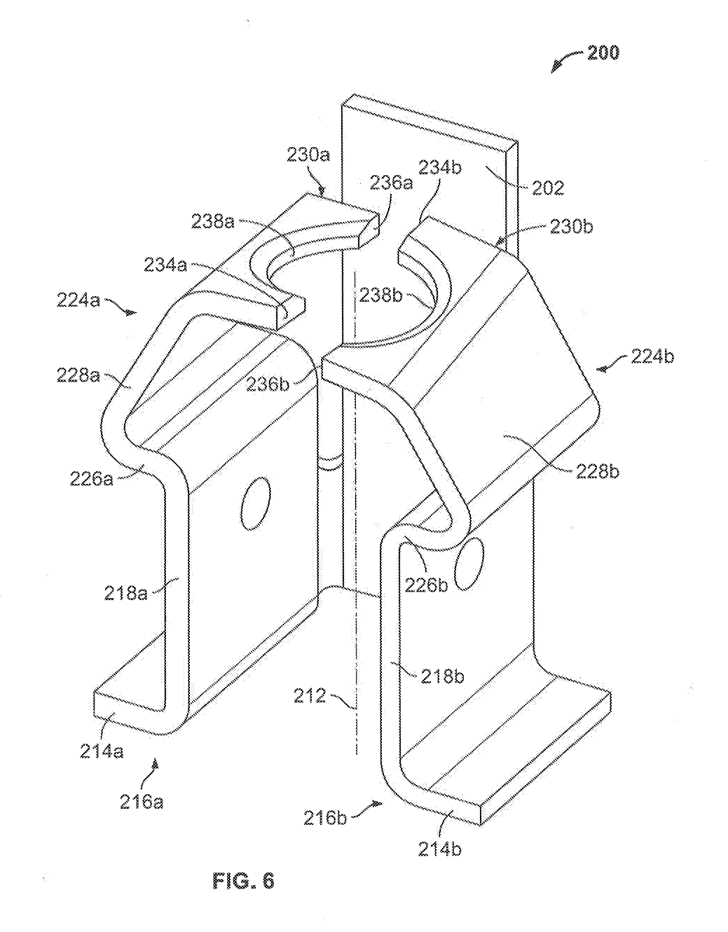

FIGS. 6 through 11 illustrate a spring nut insert 200 for use with a housing according to the invention (e.g., the housing 102 of FIG. 1) to form a push-on spring nut according to another embodiment of the invention. Generally, the spring nut insert 200 and the spring nut insert 104can include similar features, with corresponding components between the inserts 104, 200 generally identified in FIGS. 6 through 11 using similar reference numerals in the “200” series.

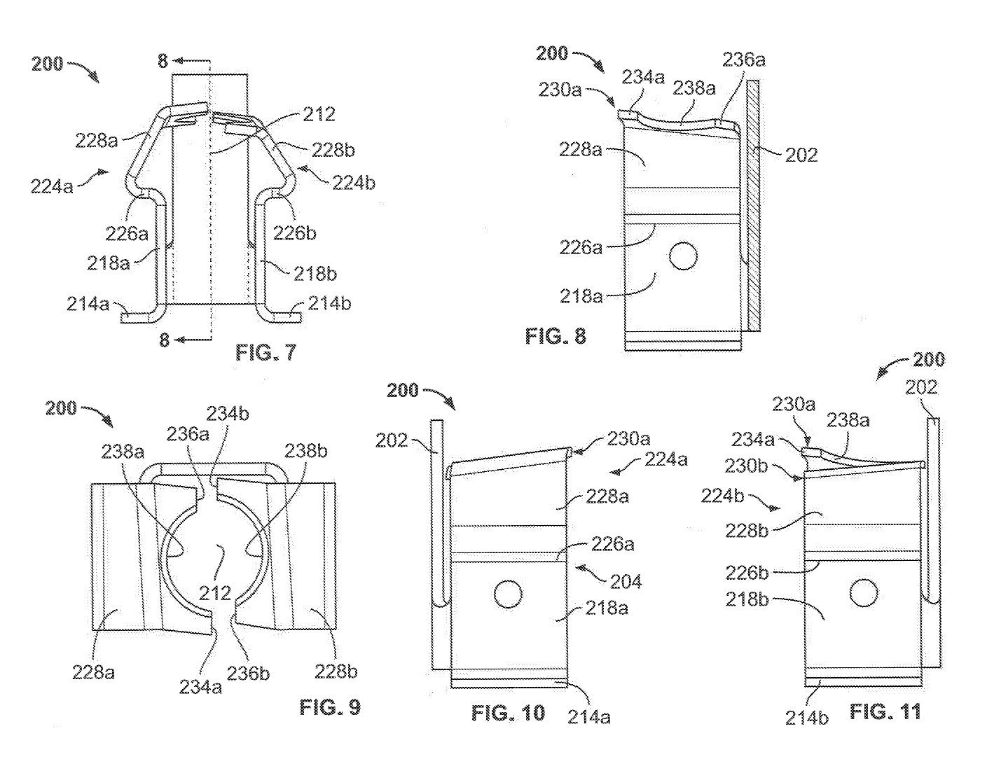

As illustrated in FIGS. 6 and 7, the spring nut insert 200 generally includes an insert base 202, and opposing first and second arms 224a, 224b, and defines a central axis 212. In the embodiment illustrated, the first arm 224a is generally similar to the second arm 224b, except as described below or shown in the FIGS. Therefore, discussion of the first arm 224a herein also generally applies to the second arm 224b. For clarity, in FIGS. 6 through 12, similar features on the first and second arms 224a, 224b are generally identified using like references numerals, with the suffix “a” denoting components on the first arm 224a and the suffix “b” denoting components on the second arm 224b.

In the embodiment illustrated, the first arm 224a is formed integrally with and extends a side of the insert base 202, via a first straight-walled support portion 218a. The first arm 224a also includes a first retaining flange 214a that extends laterally outward away from the central axis 212 from the first support portion 218a at a first end 216a of the insert first arm 224a. The first retaining flange 214a is configured to extend laterally past the first end 114 of the housing 102 (see, e.g., FIG. 1) when the spring nut insert 200 and the housing 102 are assembled, to prevent axial displacement of the spring nut insert 200 (at least in one direction) within the internal passage 102a of the housing 102. Accordingly, for example, the first retaining flange 214a can act as a stop for the spring nut insert 200, when the spring nut insert 200 is inserted into the housing 102.

As noted above, the first arm 224a includes the support portion 218a, which is arranged substantially perpendicular to the first retaining flange 214 and extends axially between the first retaining flange 214a and a support and thread-engaging end of the first arm 224a. In particular, for example, the first arm 224a generally includes a first structure-engagement portion configured as a first housing support portion 226a that extends from the support portion 218a. The first arm 224a also includes a first angled connecting portion 228a extending from the first housing support portion 226a opposite the support portion 218a, and a first thread-engaging end 230a extending from the first connecting portion 228a opposite the housing support portion 226a. Accordingly, in the embodiment illustrated, the first housing support portion 226a defines a generally S-shaped profile that extends laterally outward at an approximately 90-degree junction between the first housing support portion 226a and the first straight-walled support portion 218a, and then laterally inward and axially upward at an acutely angled junction between the first housing support portion 226a and the first connecting portion 228a.

Correspondingly, in the embodiment illustrated, the first connecting portion 228a extends axially away from the first insert end 216a and laterally inward toward the central axis 212 at an angle between zero and ninety degrees defined between the first connecting portion 228a and the central axis 212. The first thread-engaging end 230a then extends laterally inwardly from the first connecting portion 228a, from a junction that is opposite the junction between the first connection portion 228a and the first housing support portion and in substantial axial alignment with the junction between the first housing support portion 226a and the first straight-walled support portion 218a (see, e.g., FIG. 7). This may be useful during installation and loading of the insert 200, for example, as further described below.

With the spring nut insert 200 inserted into the housing 102, the first housing support portion 226a is generally dimensioned to extend laterally outward past the lower edge 132 of the window 120. Thus, when assembled, the spring nut insert 200 can be axially secured within the housing 102 by engagement between the housing 102 and the first and second retaining flanges 214a and 214b, and between the housing 102 and the first and second housing support portions 226a and 226b.

In operation, opposite thread-engaging portions of a spring nut can be configured to engage opposite sides of a threaded object. For example, the first thread-engaging end 230a is configured to engage one side of a threaded rod (not shown in FIGS. 6 through 11), with a second thread-engaging end 230b being configured to engage an opposite side of the threaded rod.

In some embodiments, thread-engaging portions of a spring nut can be contoured to provide improved engagement with a thread of a threaded object. For example, in the embodiment illustrated in FIGS. 6-11, the first thread-engaging end 230a angles generally downwardly toward the insert base 202 with a first leading edge 234a being arranged axially higher than a first trailing edge 236a (i.e., axially farther from the first retaining flange 214a than the first trailing edge 236a). Similarly, the second thread-engaging end 230b angles generally downwardly away from the insert base 202, with a second leading edge 234b being arranged axially higher than a second trailing edge 236b. Further, the leading edges 234a, 234b can extend laterally farther from the connecting portions 228a, 228b than do the trailing edges 236a, 236b, and the leading edge 234a is arranged axially higher than the leading edge 234b. In this way, for example, the first and second thread-engaging ends 230a and 230b form a general helix-like profile that is configured to engage a thread on a threaded rod.

As another example, as illustrated in FIGS. 8 through 11, the first thread-engaging end 230a includes a first curved edge 238a arranged between the first leading edge 234a and the first trailing edge 236a. As illustrated in FIG. 9 in particular, the first leading edge 234a extends laterally toward (or past) the central axis 212 farther than does the first trailing edge 236a, to provide a leading edge lead-in for engagement a thread of a threaded rod. This leading edge lead-in can ensure that the first leading edge 234a appropriately is drawn into engagement with a thread on a threaded rod when the threaded rod is initially loaded.

Generally, the first curved edge 238a can be configured for secure engagement with any variety of threads on a threaded rod. For example, the first curved edge 238a generally defines a radius of curvature that is designed to match a radius of curvature of a root of a thread on a standard threaded rod. Similarly, the first curved edge 238a is tapered to narrow from a perspective moving radially inwardly towards the central axis 212, in order to better engage a thread. Accordingly, for example, the first curved edge 238a can define a minimum thickness at a distal end thereof, as may be useful for penetration of the first curved edge 238a towards the root of a thread, between adjacent thread crests.

In some embodiments, implementing a tapered configuration on the first curved edge 238a can allow a relatively large material thickness to be used for the first arm 224a, which can provide additional general strength against buckling or other structural failure. In some embodiments, the tapered configuration of the first curved edge 238a can also provide structural advantages for engaging with a thread of a threaded rod. For example, as also noted above, the thinner end of the first curved edge 238a may generally enable the first curved edge 238a to engage a thread of a threaded rod closer to the root of the thread. Because the greatest amount of material on a thread to support a load is generally close to the root of a thread, tapering the first curved edge 238a to facilitate engagement of the first curved edge 238a at or near the root can allow the first curved edge 238a to engage the thread at an area of relatively thick material, thereby generally increasing a relevant thread shear area and stripping load.

In some embodiments, thread-engaging portions of a spring nut can exhibit other useful configurations, including compound angular profiles. In the embodiment illustrated, for example, the first thread-engaging end 230a defines a compound angled profile (e.g., as projected with respect to a central plane oriented perpendicularly to the central axis 212). In particular, the first thread-engaging end 230a includes a transition point disposed between the first leading edge 234a and the first trailing edge 236a, with different angular profiles on opposite sides of the transition point.

In some embodiments, one or more of the angular profiles on either side of the transition point can exhibit angles chosen to compromise between a helix angle of a thread on a threaded rod and a projected angle of a more interior point on the thread. In some embodiments, different angles on either side of the transition point can he selected from a projected angle corresponding to thread angles at the root diameter of a thread on a threaded rod, at a pitch diameter of the thread, at a major diameter of the thread, or otherwise. In the embodiment illustrated, for example, the side of the transition point closer to the first leading edge 234a approximates a projected angle relative to the pitch diameter of a relevant thread, and the side of the transition point closer to the first trailing edge 236a approximates a projected angle relative to the root of the thread. This may be a useful configuration, for example, in order to promote maximum engagement between a thread of a threaded rod and the first thread-engaging end 230a. In other embodiments, other configurations are possible. For example, the side of the transition point closer to the trailing edge 236a can exhibit an angle that is between those noted immediately above.

In some embodiments, different thread-engaging portions of a particular spring nut can be configured differently. For example, as illustrated in FIG. 11 in particular, the first leading edge 234a of the thread-engaging end 230a extends axially farther along the insert 200, away from the flanges 214a, 214b, than does the second leading edge 234b of the thread-engaging end 230b. In some arrangements, this configuration can dispose the leading edge 234a to engage a thread of threaded rod on an uphill side of the thread, which can tend to draw the leading edge 234a, and the curved edge 238a generally, into tighter engagement with the thread upon initial loading of the threaded rod.

When receiving a threaded rod, the general design of the spring nut insert 200 and, in particular, the angled configuration of the first and second thread-engaging ends 230a and 230b (as also discussed above), can help to compensate for differences in a projected thread angle between a thread lean-in and a projected thread angle at other locations along a thread (e.g., at a minor diameter, at a major diameter, and at a pitch diameter). In this way, for example, when a threaded rod is unloaded, the first and second leading edges 234a and 234b can be oriented somewhat askew from a thread on the threaded rod, which can allow a threaded rod to easily push through the first and second thread-engaging ends 230a and 230b (e.g., in an upward axial direction, from the illustrated perspective). Once a threaded rod is inserted and loaded, however, the first and second leading edges 234a and 234b can be deformed somewhat from their resting orientation, to be drawn into closer engagement with a thread on the threaded rod. In this regard, for example, selecting a leading-edge angle that is between the projected angles of a root diameter and a major diameter, but slightly closer to the projected angle at the root diameter, can help to bring the first and second thread-engaging ends 230a and 230b into optimal engagement with the relevant thread.

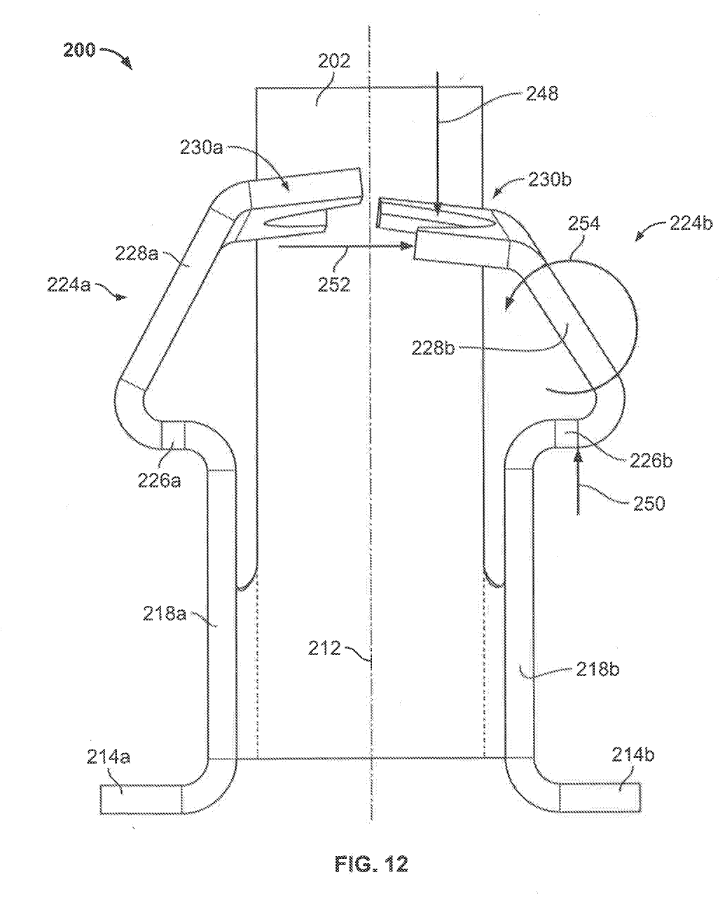

In some embodiments, other aspects of the configuration of the arms of a spring nut according to an invention can also provide improved retention with a threaded object. In some embodiments, for example, extension of a support portion of an arm laterally outwardly and extension of a connecting portion acutely inwardly from the support portion can contribute to a beneficial balance of forces upon loading of a threaded object. In the embodiment illustrated, for example, once a threaded rod that is engaged with the spring nut insert 200 is loaded, the design of the spring nut insert 200 can generally result in a balance of forces and moments that tends to bring the first and second thread-engaging ends 230a and 230b into tighter engagement with a thread in correlation with the load applied to a threaded rod. For example, as illustrated in. FIG. 12, a load applied to a threaded rod (not shown in FIG. 12) in a downward direction (from the perspective of FIG. 12) results in a generally vertical force 248 applied by the threaded rod to the second thread-engaging end 230b. This force is generally counterbalanced, so that the rod is generally supported against the load, by a generally vertical reaction force 250 on the support portion 226b. In some embodiments, for example, the reaction force 242 can result from the interaction between the housing support portion 226b and the lower edge 132 of the window 120 (see FIG. 1).

Notably, because the reaction three 250 is applied to the housing support portion 226b at a location that is laterally outside of the walled support portion 218b and the thread-engaging end 230b and, thereby, is laterally outwardly offset from the vertical force 248, a first moment is induced on the second arm 224b. A second moment in an opposite direction is also induced on the second arm 224b from a horizontal component 252 of a force generated from the angled interaction of a thread of the threaded rod with the thread-engaging end 230b. With appropriate configuration with regard to the lateral positioning of the contact between the second arm 224b and the relevant housing or other support structure (e.g., as illustrated), the first moment can generally be greater in magnitude than the second moment. Accordingly, a net moment 254 can result, which can generally urge the second thread-engaging end 230b into tighter engagement with a thread as a threaded rod is increasingly loaded. In this way, for example, the more a threaded rod is loaded, the more strongly the second arm 224b is urged into engagement with the rod and the more strongly the spring nut 200 retains the rod against the load.

Similar considerations as those discussed above for the second arm 224b also apply to the first arm 224a. For simplicity of presentation, such discussion is not repeated and relevant forces and moments are not illustrated for the first arm 224a in FIG. 12.

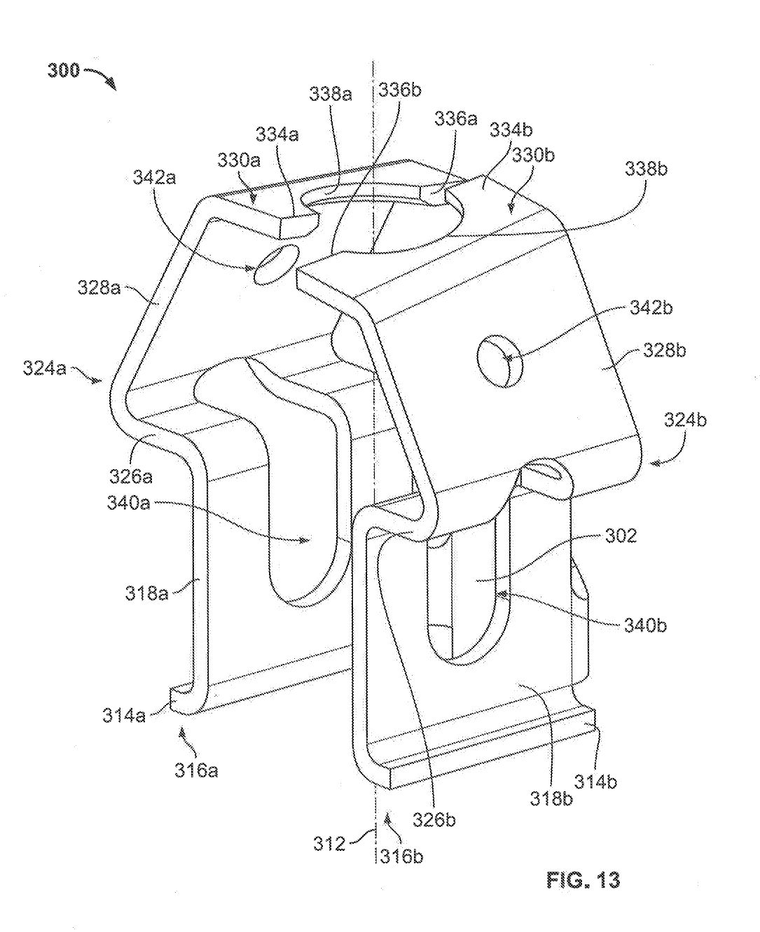

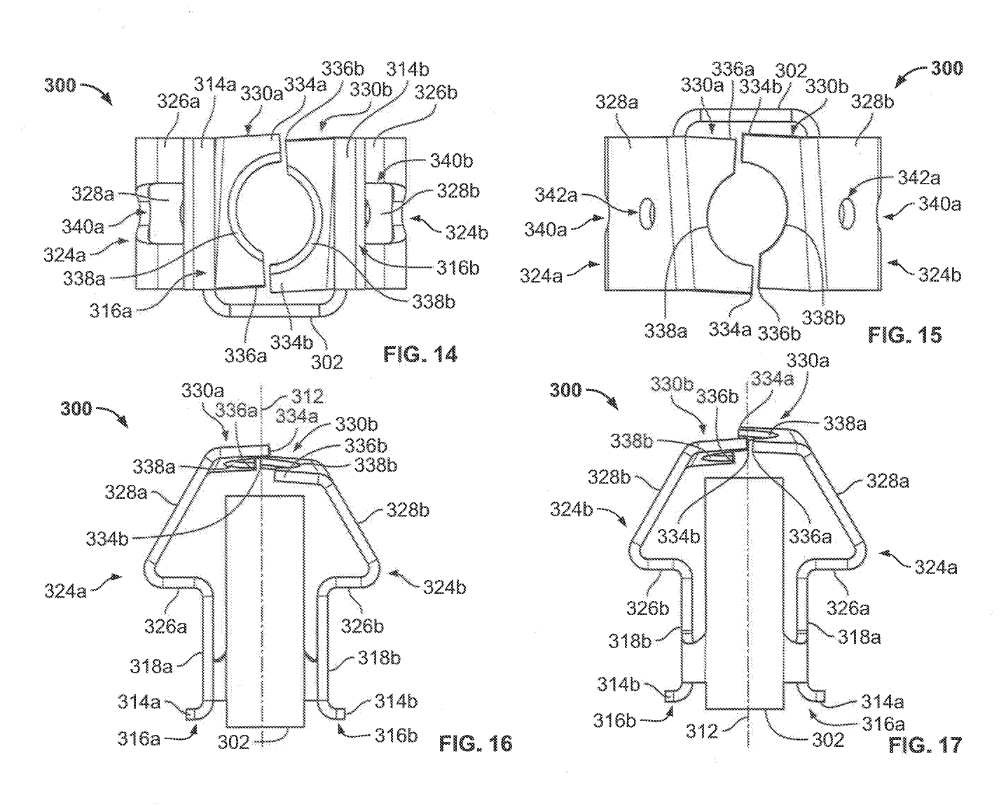

FIGS. 13 through 17 illustrate another example insert for use with a housing, (e.g., the housing 102 of FIG. 1) according to an embodiment the invention, configured as a spring nut insert 300. Generally, the spring nut insert 300 and the spring nut insert 200 can include similar features, with corresponding components generally identified in FIGS. 13 through 17 using similar reference numerals in the “300” series. Further, in view of the similarities between the spring nut inserts 104, 200 and the spring nut insert 300, discussion herein of the spring nut inserts 104, 200 generally also applies to the spring nut insert 300, except as described below or shown in the FIGS.

Similarly to the spring nut insert 200, the spring nut insert 300 includes an insert base 302, and opposing arms 324a, 324b, and defines a central axis 312 (see FIG. 16). As with the arms 224a, 224b (see, e.g., FIG. 6), in the embodiment illustrated, the first arm 324a is generally similar to the second arm 324b, except as described below or shown in the FIGS. Therefore, discussion of the first arm 324a herein also generally applies to the second arm 324b. For clarity, in FIGS. 13 through 17, similar features on the first and second arms 324a, 324b are generally identified using like references numerals, with the suffix “a” denoting components on the first arm 324a and the suffix “b” denoting components on the second arm 324b.

Generally, the first and second arms 324a, 324b are configured similarly to the first and second arms 224a, 224b (see, e.g., FIGS. 6 through 12) and, correspondingly, operate similarly during installation and use. In contrast to the arms 224a, 224b, however, the arms 324a, 324b include first and second internal slots 340a, 340b that extend continuously along axially extending straight-walled support portions 318a, 318b, along housing support portions 326a, 326b, and onto acutely-angled junctions between the housing support portions 326a, 326b and angled connecting portions 328a, 328b. The first and second slots 340a, 340b, for example, can increase the lateral flexibility of the first and second arms 324a, 324b in order to allow for relatively easy installation of the insert 300 (e.g., into the housing 102 of FIG. 1) even for embodiments formed with relatively thick material. Additional openings can also be provided, such as first and second pilot holes 342a, 342b on the first and second connecting portions 228a, 228b, as may be helpful for certain manufacturing operations.

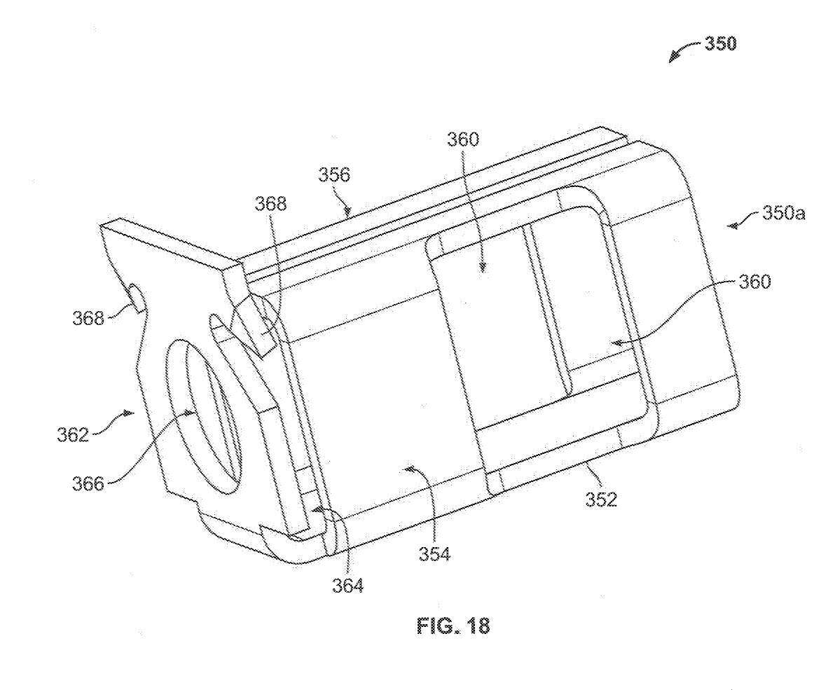

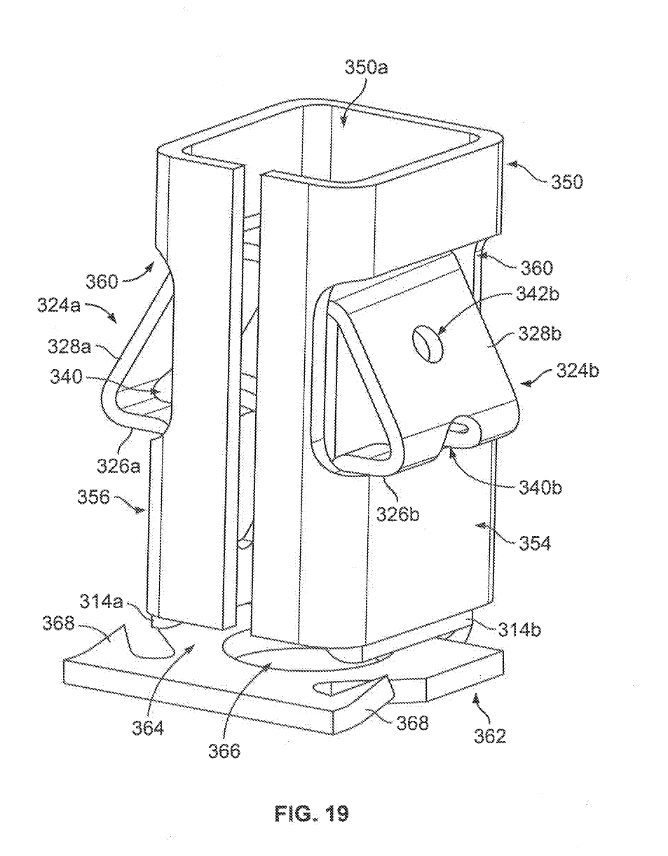

As also noted above, spring-nut inserts according to embodiments of the invention can be used with a variety of different housings and other support structures. For example, as discussed above, in some embodiments, any of the inserts 104, 200, 300 can be used with the housing 102 of FIG. 1. In some embodiments, inserts according to the invention can be used with other housings, such as a clip housing 350 illustrated in FIGS. 18 and 19. Generally, the housing 350 is configured similarly to the housing 102, with a base 352, first and second side walls 354, 356, a central passage 350a around a central axis 358, and windows 360 configured to receive and secure an insert, such as the insert 300 (see FIG. 19).

In contrast to the housing 102, a clip 362 at one end of the housing 350 extends from the base 352 laterally across the central passage 350a. In the illustrated configuration, the clip 362 extends from the base 352 to define a gap 364 between the clip 362 and the side walls 354, 356, with pointed engagement tabs 368 extending into the gap 364 towards the side walls 354. In some arrangements, a structure (not shown) such as a conduit clamp can be inserted into the gap 364, to be engaged by the tabs 368, so that the clip 362 secures the housing 350 to the structure. A threaded object, such as a threaded rod, can then be inserted into the housing 350 and the relevant insert (not shown in FIG. 18), via an aperture 366 in the clip 362 and a corresponding aperture in the structure (not shown) within the gap 364, in order to secure the threaded object to the housing 350 and to the relevant structure. In some embodiments, an insert can be inserted into the housing 350 before the clip 362 is bent to the operational configuration (e.g., as illustrated in FIG. 18). In some embodiments, an insert, such as the inserts 104, 200, 300, can be configured to be inserted from an end of the housing 350 opposite the clip 362.

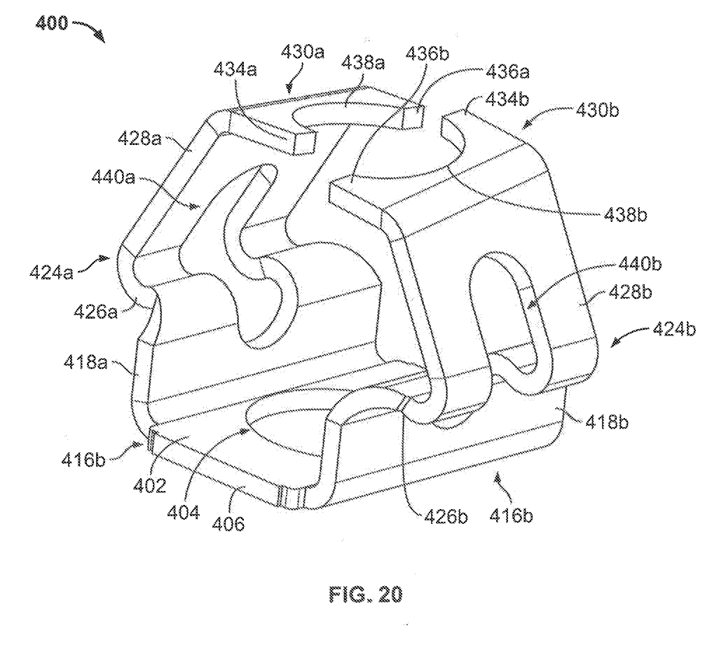

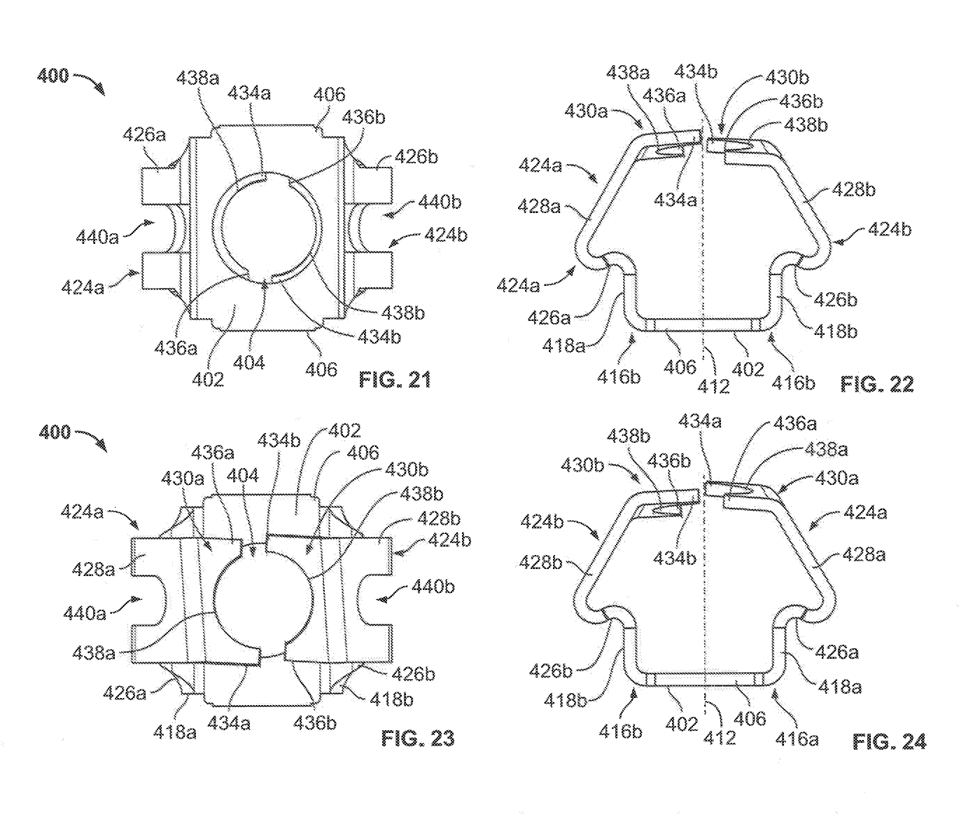

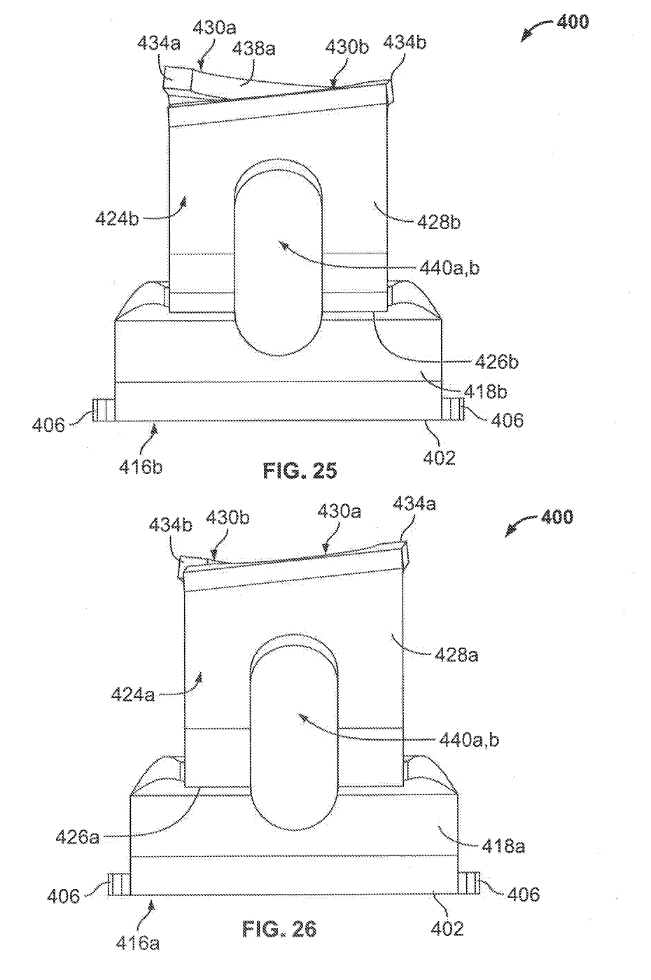

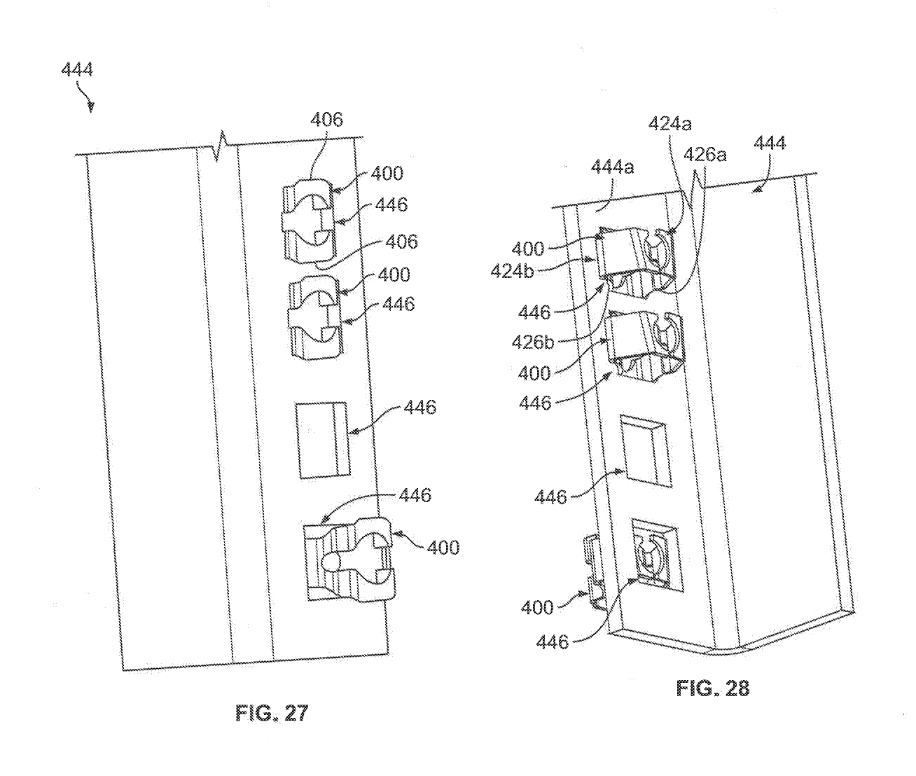

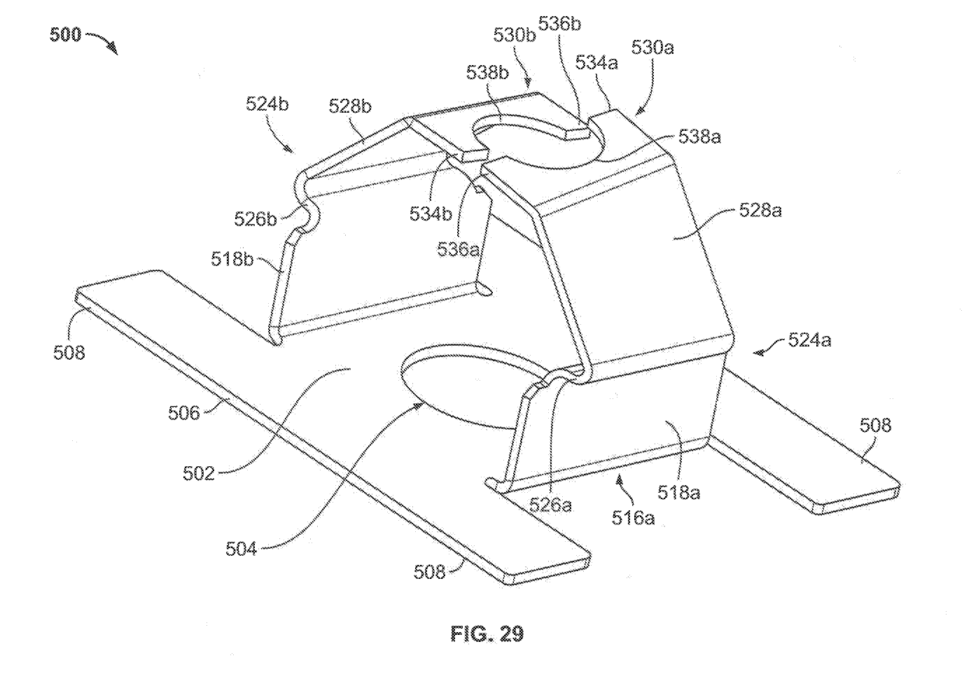

Some embodiments of the invention can be configured to be used with or without housings. Similarly, some embodiments of the invention can be configured to include single-piece spring nut bodies that directly engage a structure to attach a threaded object (e.g., rather than engaging the structure via a housing). For example. FIGS. 20 through 26 illustrate a single-piece push-on spring nut 400. In some embodiments, as also discussed below, the spring nut 400 can be directly engaged with a structure in order to secure a threaded object to the structure.

Generally, the spring nut 400 is configured similarly to the spring nut inserts 104, 200, 300, and corresponding components between the spring nut 400 and the spring nut inserts 104, 200, 300 are generally identified in FIGS. 20 through 26 using similar reference numerals in the “400” series. Further, in view of the similarities between the spring nut inserts 104, 200, 300 and the spring nut 400, discussion herein of the spring nut inserts 104, 200, 300 generally also applies to the spring nut 400, except as described below or shown in the FIGS.

Similarly to the spring nut inserts 200, 300, the spring nut 400 includes an insert base 402, and opposing arms 424a, 424b, and defines a central axis 412 (see FIG. 24). As with the arms 224a, 224b (see, e.g., FIG. 6) or the arms 324a, 324b (see, e.g., FIG. 13), in the embodiment illustrated, the first arm 424a is generally similar to the second arm 424b, except as described below or shown in the FIGS. Therefore, discussion of the first arm 424a herein also generally applies to the second arm 424b. For clarity, in FIGS. 13 through 17, similar features on the first and second arms 424a, 424b are generally identified using like references numerals, with the suffix “a” denoting components on the first arm 424a and the suffix “b” denoting components on the second arm 424b.

Generally, the first and second arms 424a, 424b are configured similarly to the arms 224a, 224b (see, e.g., FIGS. 6 through 12) or the arms 324a, 324b (see, e.g., FIGS. 13 through 17) and, correspondingly, can operate similarly during installation and use. Similarly to the arms 324a, 324b, for example, the arms 424a, 424b include straight-walled axially extending support portions 418a, 418b, which extend at somewhat acutely-angled junctions onto laterally outwardly extending structure-engagement portions 426a, 426b, which in turn extend at acutely-angled junctions onto laterally inwardly extending angled connecting portions 428a, 428b, Further, the arms 424a, 424b include first and second internal slots 440a, 440b that extend continuously along the support portions 418a, 418b, along the structure-engagement portions 426a, 426b, and onto the acutely-angled junctions between the structure-engagement portions 426a, 426b and the angled connecting portions 428a, 428b.

In some aspects, however, the arms 424a, 424b differ from the arms 224a, 224b and the arms 324a, 324b. For example, in contrast to the arms 224a, 224b and the arms 324a, 324b, the support portions 418a, 418b of the arms 424a, 424b are relatively short, as compared to the overall axial length of the spring nut 400. This may be useful, for example, to configure the spring nut 400 for direct engagement with a structure, as also discussed below.

Also in contrast to the spring nut inserts 200, 300, a base 402 of the spring nut 400 extends perpendicularly to the central axis 412, to connect axial ends 416a, 416b of the arms 424a, 424b at an axial end of the spring nut 400. Correspondingly, an aperture 404 through the base 402 is axially aligned with curved edges 438a, 438b of the arms 424a, 424b so that, for example, a threaded rod can be inserted axially through the aperture 404 and between the curved edges 438a, 438b. Further, the base 402 includes opposing tabs 406, which extend outside of the axially projected envelope of the arms 424a, 424b.

In some embodiments, the aperture 404 can provide radial support for a threaded object inserted therethrough. For example, a radius of the aperture 404 can be sized to be relatively close to an expected radius of a relevant threaded object, so that the aperture 404 can usefully restrict radial movement of the object once the object is inserted therethrough. In some embodiments, the aperture 404 can he surrounded by a raised feature, such as an extruded, non-threaded annular flange (not shown in FIGS. 20 through 26) extending from the base 402.

As also noted above, in some configurations, the spring nut 400 can be installed directly onto a structure, in order to secure a threaded object to the structure. As illustrated in FIGS. 27 and 28, for example, multiple instances of the spring nut 400 can be installed directly onto a racking angle 444 with rectangular fixing apertures 446. For example, one of the spring nuts 400 can generally be installed in one of the apertures 446 similarly to the installation of one of the spring nut inserts 104, 200, 300 into one of the housings 102, 350 (see, e.g., FIGS. 1 and 19), as described above.

In the illustrated configuration, however, rather than the arms 424a, 424b springing resiliently outwardly upon alignment with windows on a housing, the arms 424a, 424b spring resiliently outwardly upon clearing the aperture 446, so that the structure-engagement portions 426a, 426b are disposed to directly engage the racking angle 444 on a support side 444a thereof (see, e.g., FIG. 28). Further, with the spring nut 400 thus inserted through the aperture 446, the tabs 406 engage an insertion side 444a of the racking angle 444 (i.e., on an opposite side of the racking angle 444 from the structure-engagement portion 426a, 426b) to prevent further movement of the spring nut 400 through the aperture 446 in the insertion direction (see, e.g., FIG. 27).

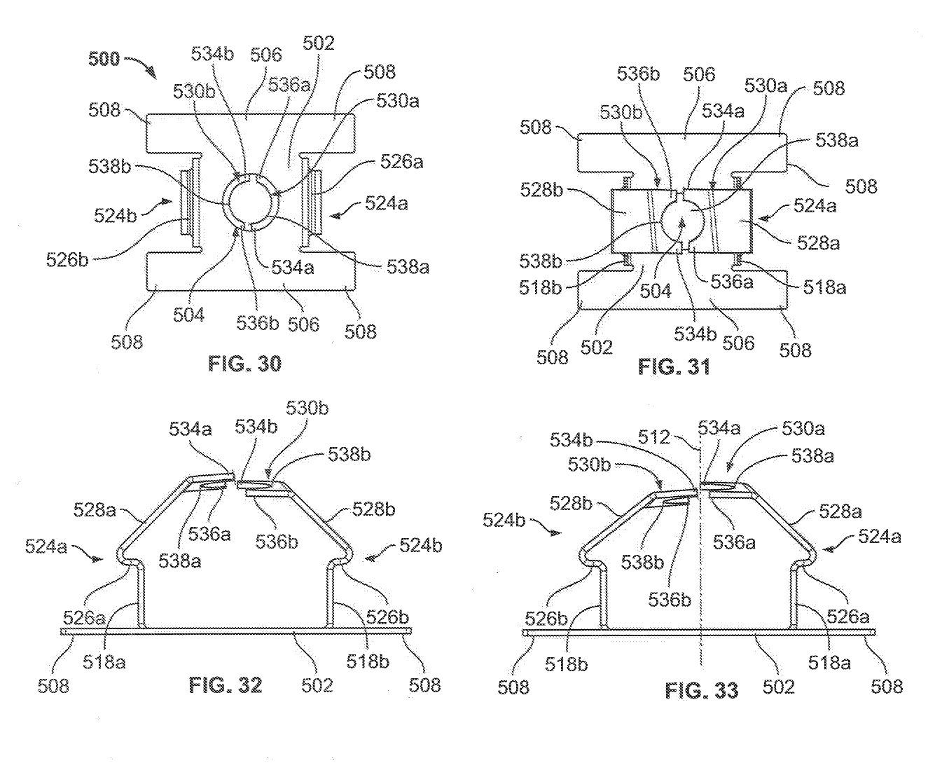

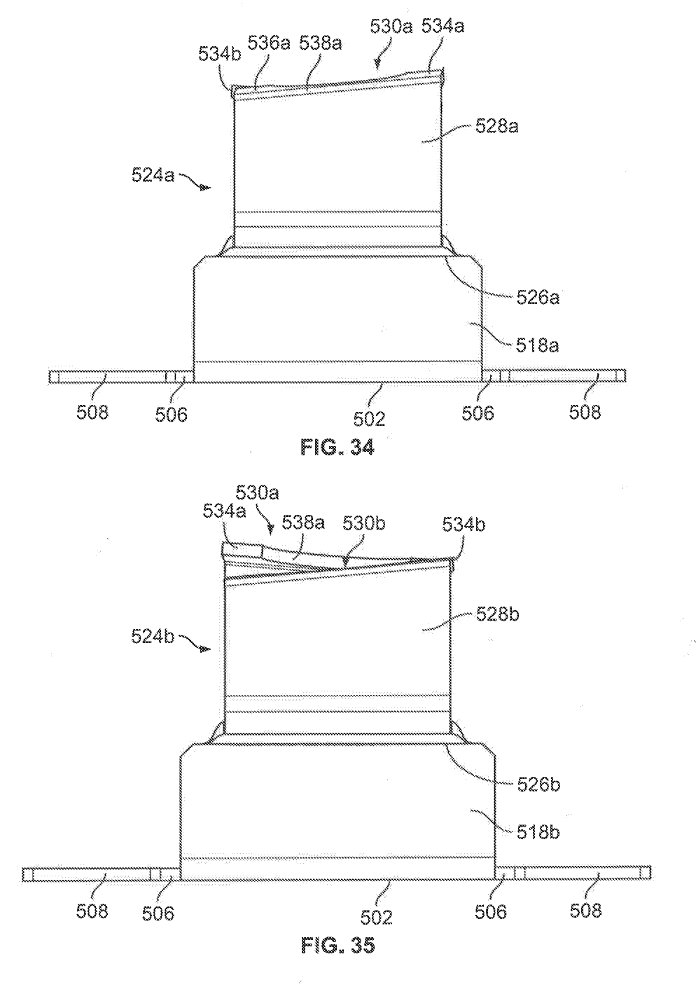

In other embodiments, other configurations are possible. For example, FIGS. 29 through 35 illustrate another single-piece push-on spring nut 500. In some embodiments, as also discussed below, the spring nut 500 can be directly engaged with a structure in order to secure a threaded object to the structure.

Generally, the spring nut 500 is configured similarly to the spring nut inserts 104, 200, 300 and the spring nut 400, and corresponding components between the spring nut 500 and the spring nut inserts 104, 200, 300 and the spring nut 400 are generally identified in FIGS. 29 through 35 using similar reference numerals in the “500” series. Further, in view of the similarities between the spring nut inserts 104, 200, 300, the spring nut 400, and the spring nut 500, discussion herein of the spring nut inserts 104, 200, 300 and the spring nut 400 generally also applies to the spring nut 400, except as described below or shown in the FIGS.

Similarly to the spring nut inserts 200, 300 and the spring nut 400, the spring nut 500 includes an insert base 502, and opposing arms 524a, 524b, and defines a central axis 512 (see FIG. 33). As with the arms 224a, 224b (see, e.g., FIG. 6), the arms 324a, 324b (see, e.g., FIG. 13), or the arms 424a, 424b (see, e.g., FIG. 20), in the embodiment illustrated, the first arm 524a is generally similar to the second arm 524b, except as described below or shown in the FIGS. Therefore, discussion of the first arm 524a herein also generally applies to the second arm 524b. For clarity, in FIGS. 29 through 35, similar features on the first and second arms 524a, 524b are generally identified using like references numerals, with the suffix “a” denoting components on the first arm 524a and the suffix “b” denoting components on the second arm 524b.

Generally, the first and second arms 524a, 524b are configured similarly to the arms 224a, 224b (see, e.g., FIGS. 6 through 12), the arms 324a, 324b (see, e.g., FIGS. 13 through 17), or the arms 424a, 424b (see, e.g., FIGS. 20 through 26) and, correspondingly, can operate similarly during installation and use. Similarly to the arms 324a, 324b, for example, the arms 524a, 524b include straight-walled axially extending support portions 518a, 518b, which extend at substantially right-angled junctions onto laterally outwardly extending structure-engagement portions 526a, 526b, which in turn extend at acutely-angled junctions onto laterally inwardly extending angled connecting portions 528a, 528b.

In the embodiment illustrated, the arms 524a, 524b do not include internal slots similar to the slots 440a, 440b (see, e.g., FIG. 20). In some embodiments, for example, the expected necessary deflection of the arms 524a, 524b for installation of the spring nut 500 may be relatively small. Accordingly, the increased flexibility provided by inclusion of features such as the slots 440a, 440b may not be necessary. For potentially similar reasons, the structure-engagement portions 526a, 526b are relatively short as compared to the structure-engagement portions 426a, 426b (see, e.g., FIG. 20).

In the illustrated embodiment, the spring nut 500 also differs from the spring nut 400 in other ways. For example, similarly to the spring nut 400, the spring nut 500 includes a base 502 that extends perpendicularly to the central axis 512, to connect axial ends 516a, 516b of the arms 524a, 524b at an axial end of the spring nut 500. Correspondingly, an aperture 504 through the base 502 is axially aligned with curved edges 538a, 538b of the arms 524a, 524b so that, for example, a threaded rod can be inserted axially through the aperture 504 and between the curved edges 538a, 538b. Further, the base 502 includes opposing tabs 506, which extend outside of the axially projected envelope of the arms 524a, 524b. In contrast to the spring nut 400, however, each of the tabs 506 includes a set of opposing legs 508 that extend laterally substantially beyond the arms 524a, 524b.

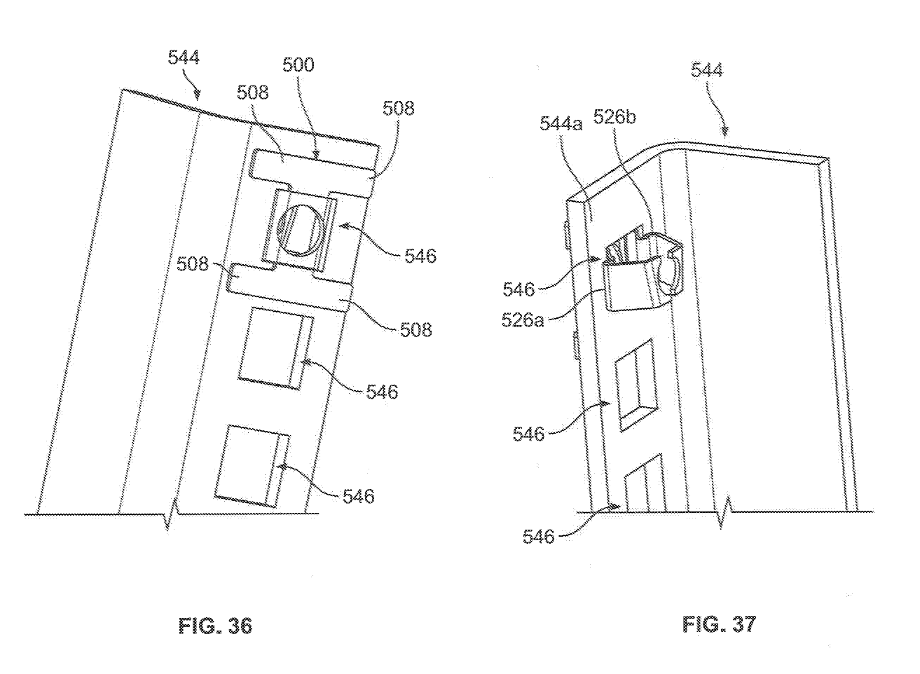

As also noted above, in some configurations, the spring nut 500 can be installed directly onto a structure, in order to secure a threaded object to the structure. As illustrated in FIGS. 36 and 37, for example, one or more instances of the spring nut 500 can be installed directly onto a racking angle 544 with rectangular fixing apertures 546. For example, one of the spring nuts 500 can generally be installed in one of the apertures 546 similarly to the installation of one of the spring nuts 400 onto the racking angle 444 (see, e.g., FIGS. 27 and 28), as described above, with the legs 508 and the structure-engagement portions 528a, 528b engaging opposite sides of the racking angle 544 adjacent to the relevant fixing aperture 546.

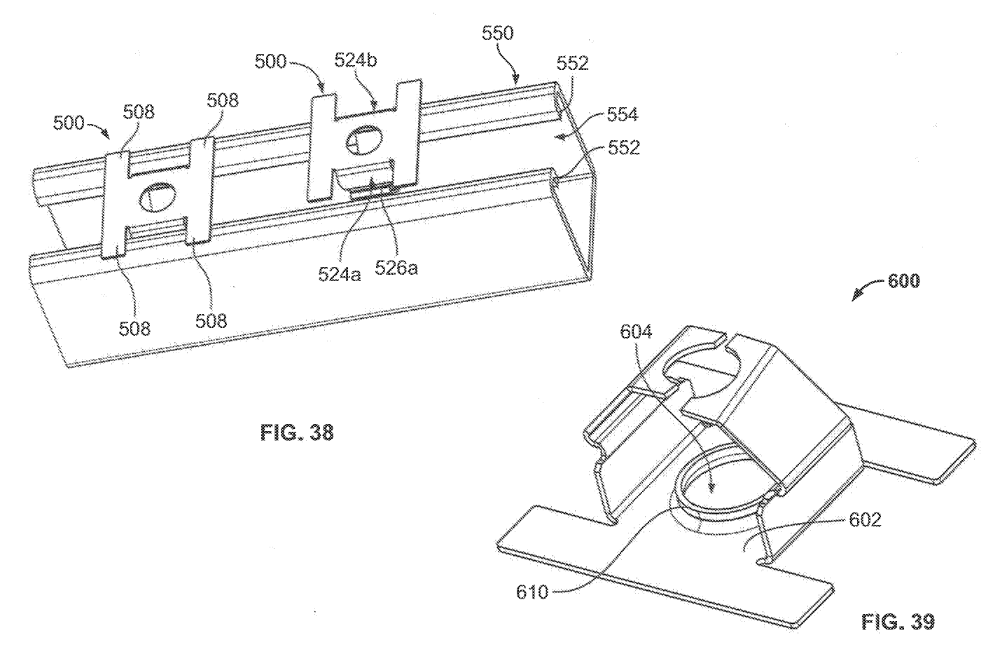

In some configurations, the spring nut 500 can also be installed directly onto other structures. As illustrated in FIG. 38, for example, multiple instances of the spring nut 50 can be installed directly onto a strut 550, with reentrant lips 552 separated by a central channel 554. Generally, the spring nut 500 can be installed on the strut 550 similarly to the racking angle 544, as discussed above. During installation on the strut 550, however, the arms 524a, 524b can resiliently spring laterally outwardly within the strut 550, so that the structure-engagement portions 526a, 526b (see also FIGS. 29 through 35) engage an interior side of each of the reentrant lips 552 to secure the spring nut 500 against axial withdrawal from the strut 550. Similarly, the legs 508 extend across the exterior side of the reentrant lips 552, to secure the spring nut 500 against over-insertion into the strut 550.

In this way, for example, the structure-engagement portions 526a, 526b and the tabs 506 can cooperate to secure the spring nut 500 within the channel 554. In this regard, for example, the relatively short length of the support portions 518a, 518b can help to minimize axial movement of the spring nut 500 relative to the strut 550, once the spring nut 500 is fully installed. Further, with the spring nut 500 thus secured, the arms 524a, 524b may still be free to flex resiliently (e.g., at the junction between the structure-engagement portions 526a, 526b and the connecting portions 528a, 528b) in order to receive and secure a threaded object (not shown in FIG. 38) that is inserted axially and non-rotationally through the apertures 504, 546 (see also FIG. 29).

As another example, FIG. 39 illustrates a spring nut 600 according to an embodiment of the invention. Generally, the spring nut 600 is configured similarly to the spring nut 500 (see, e.g., FIG. 29), and discussion above regarding the spring nut 500 generally also applies to the spring nut 600, except as described below or shown in the FIGS.

In some aspects, however, the spring nut 600 differs from the spring nut 500. For example, an aperture 604 in a base 602 of the spring nut 600 is surround by a raised feature configured as an extruded, non-threaded annular flange 610 that extends integrally from the base 602. Generally, the flange 610 can provide radial support for a threaded object extending through the aperture 604, such as a threaded rod (not shown in FIG. 39). In some embodiments, the flange 610 can be configured to extend axially away from the base 602 by at least one pitch of an expected thread.

In discuss above, certain embodiments exhibit features that are different from features of other embodiments. Generally, features described with respect to one embodiment above can be interchanged with features of other embodiments, or added as supplemental features to other embodiments. For example, a raised support feature similar to the flange 610 (see FIG. 39) or lateral support features similar to the legs 508 (see, e.g., FIG. 29) can be used with other configurations. Similarly, particular angular configurations, internal features (e.g., slots or apertures), and other features described above can be generally be included on any variety of embodiments other than those with which such configurations or features are specifically illustrated or described above.

Thus, embodiments of the invention provide a push-on spring nut for attached to a threaded object. The improved push-on spring nut can provide increased ease and safety of installation. Further, some embodiments of the invention provide a push-on spring nut including a housing and a spring nut insert, or a different single-piece body, each of which can be manufactured, respectively, from single pieces of stamped spring steel or metal. In some configurations, this can substantially simplify required manufacturing by reducing the need for secondary machining and assembly processes.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A push-on spring nut for attaching a threaded object to a structure with a first side, a second side, and an opening extending between the first and second sides, the push-on spring nut comprising:
a single-piece body that includes a base, a first arm, and a second arm;
each of the first and second arms including:
a support portion that extends from the base axially along the single-piece body;
a structure-engagement portion that extends laterally outwardly from the support portion;
a connecting portion that extends laterally inwardly from an acutely angled junction with the structure-engagement portion; and
a thread-engagement portion that extends laterally inwardly from the connecting portion opposite the acutely angled junction between the connecting portion and the structure-engagement portion; and
the first and second arms being configured to:
flex laterally inwardly as the first and second arms are urged in a first direction through the opening in the structure towards the second side of the structure;
resiliently spring laterally outwardly, upon the structure-engagement portion moving past the opening in the first direction, so that the structure-engagement portions are disposed to seat against the second side of the structure upon loading of the push-on spring nut opposite the first direction;
with the first and second arms extending through the opening, flex laterally outwardly to admit the threaded object between the thread-engagement portions upon non-rotational insertion of the threaded object along an axial insertion direction through the single-piece body; and
resiliently spring laterally inwardly to engage the thread-engagement portions with a thread of the threaded object, to secure the threaded object against non-rotational movement of the threaded object opposite the axial insertion direction.

2. The push-on spring nut of claim 1, wherein each of the acutely angled junctions between the connecting portions and the structure-engagement portions is disposed laterally to the outside of the associated support portion.

3. The push-on spring nut of claim 2, wherein each of the connecting portions extends from the associated thread-engagement portion at a junction that is substantially axially aligned with the associated support portion.

4. The push-on spring nut of claim 1, wherein each of the first and second arms is formed, respectively, as a continuous extension of the base.

5. The push-on spring nut of claim 1, with the structure configured as a strut and the opening in the structure configured as a channel between reentrant lips of the strut, wherein the structure-engagement portions are configured to seat against internal edges of the reentrant lips upon insertion of the push-on spring nut into the channel.

6. The push-on spring nut of claim 5, wherein the base includes sets of legs extending laterally outwardly relative to each of the first and second arms; and
wherein the legs are configured to engage exterior surfaces of the reentrant lips of the strut.

7. The push-on spring nut of claim 1, for attachment to a second structure, the push-on spring nut further comprising:
a housing that is configured to be attached to the second structure, the housing including a first side wall and a second side wall that collectively at least partly define an internal passage to receive the single-piece body, each of the first and second side walls including a window;
wherein the first and second arms are configured to:
flex laterally inwardly as the first and second arms are urged into the internal passage; and
resiliently spring laterally outwardly, upon the structure-engagement portion being moved into alignment with the windows, so that the connecting portions are disposed to extend through the windows and the structure-engagement portions are disposed to seat against edges of the windows upon axial loading of the single-piece body.

8. The push-on spring nut of claim 7, wherein each of the first and second arms includes a retaining flange extending laterally outwardly from the support portion; and
wherein the retaining flanges are configured to extend laterally outside of a first end of the housing, when the single-piece body is installed within the internal passage of the housing, to retain the single-piece body within the internal passage.

9. The push-on spring nut of claim 7, wherein the base extends axially along the single-piece body.

10. The push-on spring nut of claim 7, wherein the housing includes a clip that extends laterally across an end of the internal passage.

11. The push-on spring nut of claim 1, wherein the thread-engaging portions are angled relative to a plane that is perpendicular to the axial insertion direction, to accommodate engagement with the thread of the threaded object.

12. The push-on spring nut of claim 11, wherein each of the thread-engaging portions includes a leading edge and a trailing edge, and a curved edge arranged between the leading edge and the trailing edge; and
wherein the leading edge of each of the thread-engaging portions extends farther laterally inward than the trailing edge of the respective thread-engaging portion.

13. The push-on spring nut of claim 11, wherein each of the thread-engaging portions includes a leading edge and a trailing edge, and a curved edge arranged between the leading edge and the trailing edge;
wherein each of the curved edges extends at a respective first projected angle proximate the leading edge, relative to a longitudinal axis of the single-piece body, and extends at a respective second projected angle proximate the trailing edge, relative to the longitudinal axis of the single-piece body; and
wherein, for each of the curved edges, the first projected angle is different from the second projected angle.

14. The push-on spring nut of claim 13, wherein each of the first projected angles is at least one of:
selected from a value that is greater than a projected angle of the thread at a root of the thread and smaller than a projected angle of the thread at a pitch diameter of the thread; or
selected from a value that is closer to the projected angle of the thread at the root of the thread than to the projected angle of the thread at the pitch diameter of the thread.

15. A push-on spring nut for attaching a threaded object to a structure with a first side, a second side, and an opening extending between the first and second sides, the push-on spring nut comprising:
a single-piece body that includes a base, a first arm, and a second arm;
each of the first and second arms being formed as a continuous extension of the base that includes:
a support portion that extends from the base to extend axially along the single-piece body;
a structure-engagement portion that extends laterally outwardly from an right-angle or acutely angled junction with the support portion;
a connecting portion that extends laterally inwardly from an acutely angled junction with the structure-engagement portion; and
a thread-engagement portion that extends laterally inwardly from the connecting portion;
the single-piece body being configured to be pushed partly through the opening in a first direction, to move the structure-engagement portion and the connecting portion past the opening and seat the structure-engagement portion against the second side of the structure to support the single-piece body against axial loading opposite the first direction; and
the first and second arms being configured to flex laterally outwardly, to admit the threaded object between the thread-engagement portions upon non-rotational insertion of the threaded object through the single-piece body in the first direction, and to resiliently spring laterally inwardly to engage the thread-engagement portions with a thread of the threaded object, to secure the threaded object against non-rotational movement of the threaded object opposite the first direction.

16. The push-on spring nut of claim 15, for attachment to a second structure, the push-on spring nut further comprising:
a single-piece housing that is configured to be attached to the second structure, the single-piece housing including a first side wall and a second side wall that collectively at least partly define an internal passage, and each of the first and second side walls including a window;
wherein the first and second arms are configured to:
flex laterally inwardly as the first and second arms are urged into the internal passage; and
resiliently spring laterally outwardly, upon the structure-engagement portion moving into alignment with the windows, so that the connecting portions are disposed to extend through the windows, and the structure-engagement portions seat against edges of the windows upon axial loading of the single-piece body.

17. The push-on spring nut of claim 15, wherein the thread-engaging portions are angled relative to a plane that is perpendicular to the first direction, to accommodate engagement with the thread of the threaded object; and
wherein each of the thread-engaging portions includes a leading edge and a trailing edge, and a curved edge arranged between the leading edge and the trailing edge, each of the trailing edges being disposed axially farther from the associated support portion than is the associated leading edge.

18. The push-on spring nut of claim 15, wherein each of the thread-engaging portions includes a leading edge and a trailing edge, and a curved edge arranged between the leading edge and the trailing edge;
wherein each of the curved edges extends at a respective first projected angle proximate the leading edge, relative to a longitudinal axis of the single-piece body, and extends at a respective second projected angle proximate the trailing edge, relative to the longitudinal axis of the single-piece body; and
wherein, for each of the curved edges, the first projected angle is different from the second projected angle.

19. The push-on spring nut of claim 18, wherein each of the first projected angles is at least one of:
selected from a value that is greater than a projected angle of the thread at a root of the thread and smaller than a projected angle of the thread at a pitch diameter the thread; or
selected from a value that is closer to the projected angle of the thread at the root of the thread than to the projected angle of the thread at the pitch diameter of the thread.

20. A method of installing a push-on spring nut to support a threaded object relative to a structure, the structure including a first side, a second side, and an opening extending between the first and second sides, and the push-on spring nut including a single-piece body that includes a base, a first arm, and a second arm, each of the first and second arms being formed as a continuous extension of the base that includes a support portion that extends from the base to extend axially along the single-piece body, a structure-engagement portion that extends laterally outwardly from an right-angle or acutely angled junction with the support portion, a connecting portion that extends laterally inwardly from an acutely angled junction with the structure-engagement portion, and a thread-engagement portion that extends laterally inwardly from the connecting portion, the method comprising:
urging the single-piece body in a first direction into the opening in the structure to cause the connecting portions to bear on the structure at the opening to flex the first and second arms inwardly, the one first and second arms thereafter resiliently springing laterally outwardly upon the structure-engaging portion moving clear of the opening in the first direction;
inserting the threaded object through the single-piece body along the first direction to engage the thread-engagement portion and cause the first and second arms to flex laterally outwardly to admit the threaded object between the thread-engagement portions, the first and second arms thereafter resiliently springing laterally inwardly to secure the threaded object against non-rotational movement of the threaded object opposite the first direction; and
loading the threaded object opposite the first direction to urge the structure-engagement portions of the into the second side of the structure to support the threaded object relative to the structure.
